(19) United States
(12) Patent Application Publication
(10) Pub. No.: US 2012/0053839 A1
(43) Pub. Date: Mar. 1, 2012

(54) METHOD OF DETECTING OR MONITORING A SUBSURFACE HYDROCARBON RESERVOIR-SIZED STRUCTURE

(75) Inventors: Simone Kugler, Stavanger (NO); Sascha Bussat, Stavanger (NO); Peter Hanssen, Stavanger (NO)

(73) Assignee: STATOIL ASA, Stavanger (NO)

(21) Appl. No.: 13/146,766

(22) PCT Filed: Jan. 29, 2010
(86) PCT No.: PCT/EP2010/051085

§ 371 Date: Sep. 20, 2011

(30) Foreign Application Priority Data
Jan. 29, 2009 (GB) 0901449.9

(51) Int. Cl. G06F 19/00

(52) U.S. Cl. 702/13

(57) ABSTRACT

Subsurface hydrocarbon reservoir-sized structures are detected or monitored by ambient noise tomography. Interface wave data are recorded for interface waves excited by seismic ambient noise. The data are recorded simultaneously at pairs of locations with the locations of each pair being spaced by less than or equal to a wavelength at the frequencies of interest. The recorded data are processed (3-7) by tomography to obtain group-velocity and/or phase-velocity tomograms, which are inverted to obtain seismic parameters values, such as seismic velocity. The seismic parameters may then be used to form a geological model (8) of a subsurface region of interest.

The present invention relates to a method of detecting or monitoring a subsurface hydrocarbon reservoir-sized structure by ambient noise tomography. The present invention also relates to a program for programming a computer to perform such a method, a computer-readable medium containing such a program, transmission of such a program via a transmission medium and a computer programmed by such a program.

A known ambient noise surface-wave tomography technique is disclosed in Shapiro, N. M., Campillo, M., Stehly, L., Ritzwoller, M. H. (2005), High-resolution surface-wave tomography from ambient seismic noise, Science, 307, 1615-1618. Such a technique is used to infer images of the earth's crust. However, the distances between “stations” at which seismic transducers are located is relatively large, for example, greater than 50 Km. Similarly, processing of pairs of data records are such that path lengths shorter than about two wavelengths at the frequencies of interest are rejected. Such a technique therefore has relatively low spatial resolution and is not capable of resolving or detecting hydrocarbon reservoir-size structures.

Another surface wave tomography technique is disclosed in Brenguier, F., Shapiro, N. M., Campillo, M., Nercessian, A., Ferrazzini, V. (2007), 3-D surface wave tomography of the Piton de la Fournaise volcano using seismic noise correlations, Geophysical Research Letters, 35, L02305. This technique is used to infer the structure of a volcano. However, the technique again uses inter-station distances which are relatively large and, in particular, greater than a wavelength at the frequencies of interest. Again, such a technique is not capable of resolving hydrocarbon reservoir-sized structures because it provides insufficient spatial resolution in the processed data.

It is also known to use tomography with body waves, as opposed to interface (or “surface”) waves, resulting from earthquakes. An example of this technique was disclosed in Mallick B. & Drummont J. (1999), The use of earthquake energy for structure tomography in the northern Ucayali Basin., INGEPET-2-BM.

According to a first aspect of the invention, there is provided a method of detecting or monitoring a subsurface hydrocarbon reservoir-sized structure by ambient noise tomography, comprising the steps of:
obtaining ambient noise interface wave data at a plurality of pairs of locations, where the interface wave data at the locations of each pair are obtained simultaneously and the distance between the locations of each of at least some of the pairs is less than or substantially equal to a wavelength of a frequency of interest;
processing the interface wave data at the pairs of locations by tomography to obtain group-velocity and/or phase-velocity tomograms; and
inverting the tomograms to obtain seismic parameter values.

Ambient noise interface wave data may, for example, be excited by natural sources, such as wind and waves hitting the shore, or by anthropogenic sources such as traffic or production noise.

The method may comprise the further step of forming a geological model from the seismic parameter values.

The seismic parameter values may be seismic velocity values.

The interface wave data may comprise Rayleigh and/or Love and/or Scholte wave data.

The interface wave data at the locations of each pair may be obtained simultaneously for a time interval of less than ten days. The time interval may be greater than or substantially equal to 30 minutes. Increasingly the time interval tends to increase the data quality but long intervals may be unnecessary or undersirable.

The distance between the locations of each of the at least some pairs may be less than or substantially equal to the wavelengths of all frequencies of interest.

The interface wave data may be in a frequency range greater than or substantially equal to 0.01 Hz and less than or substantially equal to 2 Hz. For example, the frequency range may be chosen according to the depth of a target zone; the nature of surface waves is such that they penetrate deeper for longer wavelengths. If an approximated shear-wave velocity model is available, the penetration for different frequencies may be calculated and the frequency range of interest for a given target depth may be determined. It may also be important to record frequencies exceeding the frequency range of interest, for example to overcome trade-off problems within an inversion to a shear-wave velocity model.

The interface wave data may be amplitude-normalised.

The processing step may comprise cross-correlating the interface wave data for each pair of locations. The processing step may comprise extracting Green's functions from the cross-correlations.

The processing step may comprise converting the interface wave data from the distance-time domain to the slowness-frequency or velocity-frequency or wavenumber-freqeuncy domain.

The processing step may comprise forming a mean of the group and/or phase dispersion of the interface wave data, determining residual group and/or phase dispersion with respect to the mean, and performing tomography on the residual group and/or phase dispersion. The processing step may comprise providing sensitivity kernels connecting the residual group and/or phase dispersion to the seismic parameter values at a plurality of different frequencies.

The processing step may comprise providing 3-D sensitivity kernels connecting directly residual travel times from a Green's function to seismic values at a plurality of different frequencies.

At least some of the locations may be disposed around and above the position of a salt diapir.

At least some of the locations may be disposed around a well at different times for monitoring reservoir property variations during production.

The method may comprise selecting the frequency of interest so as to provide the seismic parameters at a depth of interest.

The method may comprise performing the processing and inversion steps for a plurality of frequencies of interest to provide the seismic parameters at a plurality of depths of interest so as to provide three dimensional seismic information.

According to a second aspect of the invention, there is provided a program for programming a computer to perform a method according to the first aspect of the invention.

According to a third aspect of the invention, there is provided a computer-readable medium containing a program according to the second aspect of the invention.

According to a fourth aspect of the invention, there is provided a computer programmed by a program according to the second aspect of the invention.

According to a fifth aspect of the invention, there is provided an apparatus arranged to perform a method according to the first aspect of the invention.

It is thus possible to provide a technique with greatly improved spatial resolution, such as lateral spatial resolution, to allow detection or monitoring of hydrocarbon reservoir-sized subsurface structures. Typical hydrocarbon-bearing structures have dimensions of a few kilometres and the present technique allows such structures to be resolved.

The present technique is “passive” in the sense that it is unnecessary to provide an active seismic source. Thus, data acquisition techniques may be used which are much less expensive than active seismic surveying techniques. Also, it is possible to explore the subsurface structure of regions where active seismic techniques are not allowed, for example, because of interference with whales in the case of marine environments. It is also possible to explore regions, such as jungles and mountains, where active techniques are inconvenient or impractical.

The present invention will be further described, by way of example, with reference to the accompanying drawings in which:

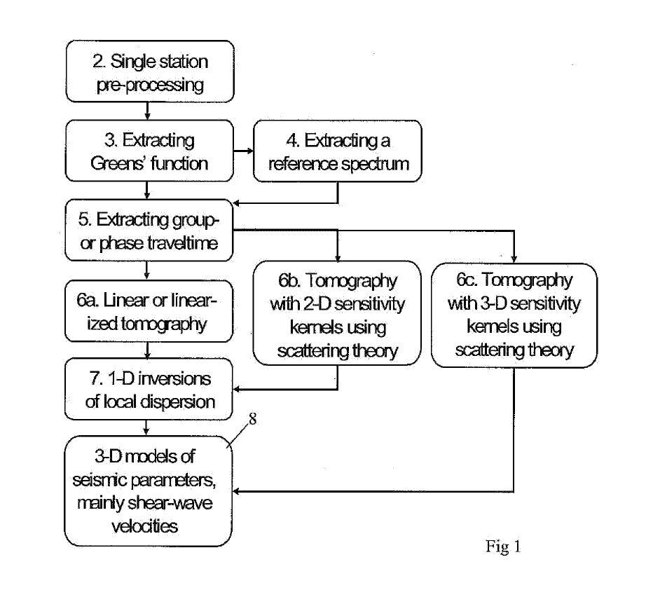

FIG. 1 is a flow diagram illustrating a method constituting an embodiment of the invention;

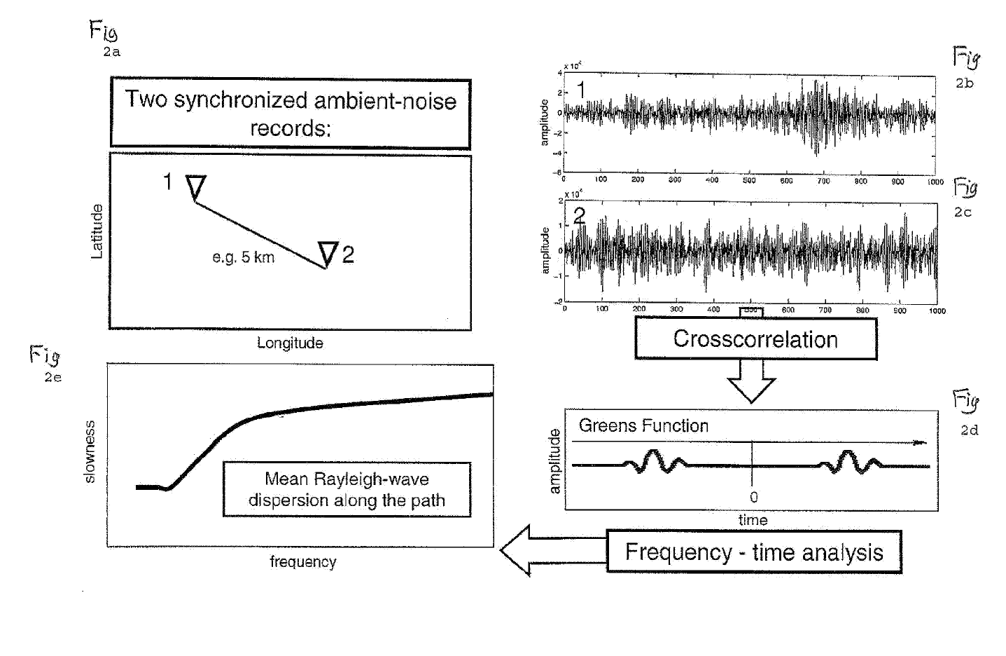

FIG. 2a illustrates diagrammatically an arrangement of a pair of simultaneous transducers stations;

FIGS. 2b and 2c illustrate recorded data or traces obtained by the stations in FIG. 2a;

FIG. 2d illustrates the cross-correlation function of the traces of FIGS. 2b and 2c;

FIG. 2e illustrates mean Rayleigh-wave dispersion resulting from frequency-time analysis of the function in FIG. 2d;

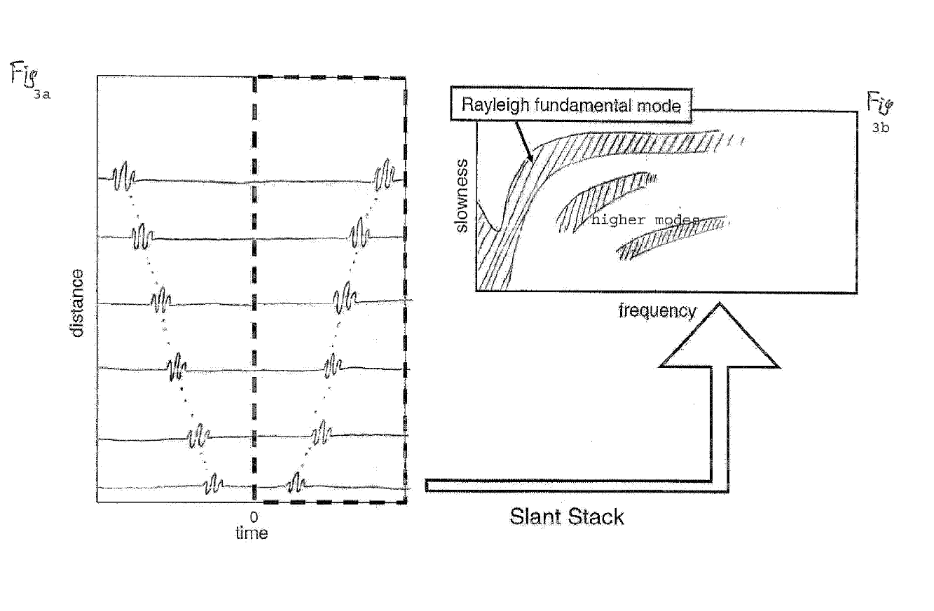

FIG. 3a illustrates a plurality of cross-correlation functions sorted by inter-station distance;

FIG. 3b illustrates a phase-slowness frequency spectrum derived from the functions shown in FIG. 3a;

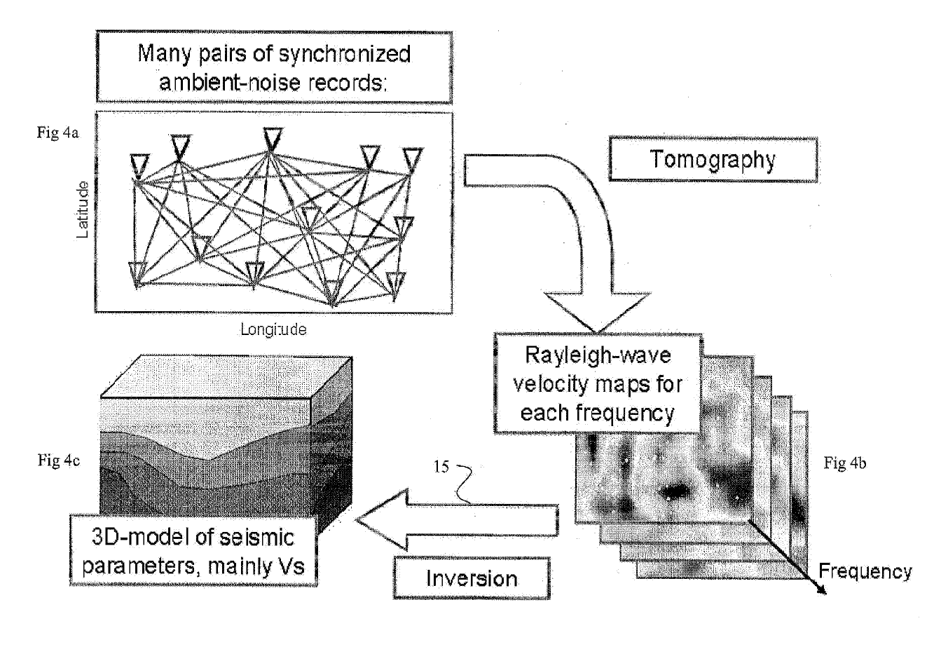

FIG. 4a illustrates an example geometry of pairs of synchronised ambient noise recording stations;

FIG. 4b illustrates Rayleigh-wave velocity maps for different frequencies;

FIG. 4c illustrates a three-dimensional model of seismic parameters obtained from the maps of FIG. 4b; and

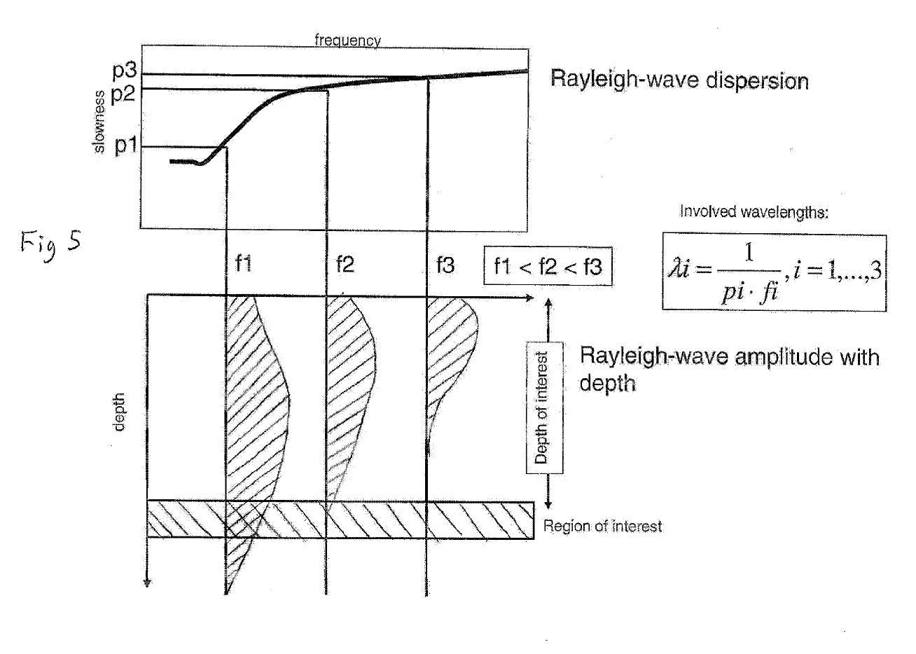

FIG. 5 is a diagram illustrating Rayleigh-wave dispersion and amplitude with depth against frequency.

The method described in detail hereinafter may be used for detecting geological structures which are of the scale or size of structures capable of acting as hydrocarbon reservoirs. However, this technique may also be used to monitor a known hydrocarbon reservoir structure, for example during depletion of an existing well by injection of water. The technique may be used in hostile locations, for example, in the Artic or Antarctic regions of the earth or in jungle-covered regions or mountainous regions. This technique may also be used for locations whose geology causes problems for other techniques, for example, above or in the neighbourhood of salt domes or diapirs beneath basalt layers.

This technique may be used with existing data which have already been captured, provided the inter-station distances of at least some pairs of stations providing simultaneous data records are less than or substantially equal to one wavelength of a frequency of interest and typically of all frequencies of interest. Thus, recorded ambient noise data for surface waves may be available for processing in accordance with the present technique. Alternatively or additionally, such interface wave data may be gathered for processing by means of the present technique.

Data may be gathered by recording ambient vibrations of the subsurface, for example, on land with seismic monitors and/or geophones or at the sea floor with seismic monitors, geophones and/or hydrophones. Recordings may be made at all locations covering the region of interest simultaneously or simultaneous recordings may be made with at least two stations with the stations being moved from time to time so as to cover an area of interest with relatively few transducers. However, only pairs of records which were obtained at least partially simultaneously may be processed together as described hereinafter. Simultaneous recordings or sections of recordings are typically required for a time interval of at least one hour but recordings of the order of a few hours or a day are generally sufficient for the present technique. The data quality will, however, generally improve for longer time intervals of recording. For short time intervals of simultaneous recording (shorter than about 4 hours), it might be necessary to enhance the signal by suppressing transient events (e.g. from earthquakes) by statistical data selection, for example using the technique disclosed by Groos and Ritter (2008; submitted to Geophysical Journal International) and the Diploma thesis by Joern Groos (2007).

The recording stations, at which the transducers are simultaneously located for providing simultaneous data, are arranged such that the inter-station distance is less than or substantially equal to a wavelength of a frequency, and typically all of the frequencies, of interest. The frequency range of interest is typically between 0.01 Hz and 2 Hz. In the case where a large area is covered by an array, such as a regular array, of transducer stations, many but not all pairs selected from the stations will have an inter-station distance which fulfils this requirement. The data recorded at such pairs of stations are processed as described hereinafter. Although it is not necessary to process data recorded at pairs of stations with a greater inter-station spacing, such data may also be processed according to the present technique. For example, the locations of the transducer stations and the choice of pairs of stations selected for processing together may be such as to include inter-station distances from a fraction of a wavelength up to the order of two wavelengths for the frequency range of interest. For a relatively large frequency range of interest, the range may be divided into a plurality of sub-ranges or discrete frequencies with selection of data locations for processing in each range or at each frequency such that inter-station distances fall within such a range, but always include spacings which are less than or substantially equal to a wavelength.

The transducers may be arranged to be sensitive only to the vertical components of interface waves, or only the vertical components may be used for processing, if it is desired to apply this technique to Rayleigh waves. If horizontal components are also recorded or selected, then the radial component of Rayleigh waves may be investigated and Love wave analysis may also be performed.

The interface wave data recorded at each station may be subjected to preliminary individual processing so as to improve the quality of the recorded data, for example, so as to enhance the signal-to-noise ratio, in order to improve the results of the subsequent processing steps. For example, bandpass filtering may be applied so as to attenuate or suppress data outside the frequency range of interest. Spectral whitening within the frequency range of interest may be applied. Spectral whitening is the process of weighting the complex spectrum of the ambient noise record by the inverse of a smoothed version of the amplitude spectrum. This process makes it possible to broaden the band of the ambient noise signal in the cross correlations and is important because ambient noise has usually a quite small spectral bandwidth.

Amplitude normalisation may be applied and several techniques may be used individually or in combination. Such techniques include automatic gain control, route-mean-square (RMS) clipping, and one-bit normalisation, for example, by converting each sample to a value of 1 for a positive sample value and a value of −1 for a negative sample value. Such single station pre-processing is illustrated in a step 2 as show in FIG. 1.

Processing of the recorded data then continues with a step 3 for extracting a Green's function. As shown in FIG. 2a, each pair of transducer stations S1 and S2 (where data were recorded simultaneously and whose separation is as described hereinbefore) is selected and the recorded interface wave data from the stations S1 and S2 are processed. The stations S1 and S2 have locations which are typically separated, for example, laterally, by a few kilometres and the example shown in FIG. 2a is such that the stations are separated by 5 kilometres. Examples of simultaneously recorded or synchronised data are shown in FIGS. 2b and 2c from the stations S1 and S2, respectively. The recorded data are then subjected to cross-correlation as indicated at (10) to provide a cross-correlation function or data shown in FIG. 2d. The cross-correlation function may be calculated for the whole of the simultaneously recorded data. As an alternative, the recorded data may be divided into “time-pieces” which are then cross-correlated and stacked or added together to provide the cross-correlation function. The Green's function is then obtained from the cross-correlation function either by calculating the negative time-derivative of only the part of the cross-correlation function at positive times or by calculating the negative time-derivative of a stack of the parts of the cross-correlation function at negative and positive times. When performed on the vertical components of the recorded interface wave data, the Green's function is dominated by Rayleigh waves.

In order to process horizontal components of the recorded interface wave data, the two-dimensional components are rotated to provide a radial component in the direction of the line connecting the stations S1 and S2 and a transverse component perpendicular to this direction. The Green's function is then extracted for the transverse and radial components as described above for the vertical component. The radial component Green's function provides Rayleigh wave information, which is typically dominated by higher modes as compared with the vertical component. The transverse Green's function provides Love wave information.

As indicated at 11, frequency-time analysis is performed for each Green's function so as to provide the spectrum shown in FIG. 2e. The mean Rayleigh-wave dispersion for propagation between these stations S1 and S2 may then be inferred by selecting the local maxima illustrated by the curve 12.

A step 4 then extracts a reference dispersion by extracting reference phase velocities as a function of frequency. In order to extract the reference Rayleigh and Love-wave phase velocities, the Green's functions for each component (vertical, transverse, radial) are sorted according to inter-station distance. For example, FIG. 3a illustrates the sorted data for the vertical component. All available Green's functions are transformed from the distance-time domain to the phase-slowness time intercept domain by a slant stack followed by a 1-D Fourier transform of each trace resulting in a phase-slowness frequency spectrum. This transform is described in McMechan G. A. & Yedlin, M. (1981), Analysis of Dispersive Waves by Wavefield Transformation, Geophysics, 46, 869-874. It is also possible to first apply the 1-D Fourier transform and then calculate the slant stack in the frequency domain (Park, Choon B.; Miller, Richard D.; Xia, jianghai (1999), Geophysics, vol. 64, issue 3, p. 800), or to apply a 2-D Fourier transform to represent the wavefield in the frequency-wavenumber domain (Muyzert, E., 2000, Scholte wave velocity inversion for a near surface Svelocity model and P-S-statics: 71^{st} Annual International Meeting, Society of Exploration Geophysicists, Expanded Abstracts, 1197-1200.). The resulting stack is shown as a phase-slowness frequency spectrum in FIG. 3b. The resulting slowness-frequency spectra for the different components give a measure of the dominant slowness (or the velocities) as a function of frequency for all of the interface or surface waves excited by ambient noise.

A step 5 then extracts group or phase travel time or velocities from the Green's functions for each pair of simultaneously recorded interface wave data. The analytical signal of each Green's function is calculated using a Hilbert transform. The analytical signal is then filtered by a set of narrow band-pass Gaussian filters. The absolute value of the filtered analytical signal for the different filter-frequencies gives the group velocity-frequency spectrum. A technique of this type is, for example, disclosed in Bensen, G. D., Ritzwoller, M. H., Barmn, M. P., Levshin, A. L., Lin, F., Moschetti, M. P., Shapiro, N. M., Yang, Y. (2007), Processing seismic ambient noise data to obtain reliable broad-band surface wave dispersion measurements, Geophys. J. Int 169, 1239-1260.

The dispersion curves are then determined by selecting the local maxima. The frequency range over which the different modes are dominant is extracted from the reference phase-velocity-frequency spectra determined in the step 4.

From the group velocities for all traces, the mean group dispersion is calculated. Only the residuals to this mean are used as input to the following tomography.

For extracting phase velocity, each Green's function is corrected for the reference dispersion determined in the step 4 by applying a frequency-dependent phase-shift to the “traces”. The corrected traces are then muted such that all of the amplitudes except for those near to zero travel time are set to zero. The edges of the time window are then tapered. The width of the passing window depends on the amount of lateral inhomogeneity, which represents how strongly the dispersion of each trace differs from the reference dispersion. The phases of the resulting traces are determined by a Fourier transform. If the amount of lateral variation is not too high, all of the phases should be smaller than 2π and the inferred phases may be directly used as input for the following tomography without unwrapping. This method is described in detail in Kugler, S., Bohlen, T., Forbriger, T. Bussat, S., Klien G., Scholte-wave tomography for shallow-water marine sediments (2007), Geophysical Journal International, Volume 168 Issue 2, Pages 551-570 for active interface-wave data.

A step 6a then performs linear or linearised tomography. The measured group and phase speed residuals from the step 5 are used for the linear tomography. It is assumed that the phase of the waves in the Green's function have only been influenced by the medium along the direct path connecting the stations such as S1 and S2. The tomography is then a linear easily solvable problem (Kugler, S., Bohlen, T., Forbriger, T. Bussat, S., Klein, G., Scholte-wave tomography for shallow-water marine sediments (2007), Geophysical Journal International, Volume 168 Issue 2, Pages 551-570).

Damping is applied during tomographic inversion. Smoothing may be applied during or after the inversion. The result may be calculated in one step without iteration.

However, for better lateral resolution and reduced systematic errors, the strong linearisation may be overcome by applying ray-tracing using only small model variations and performing an iterative tomography.

The assumption behind the direct-path approach and the ray-tracing approach of the step 6a is that of a wave with infinite frequency. In order to consider finite-frequency effects, it is possible to calculate two-dimensional sensitivity kernels which connect velocity variations with resulting phase-residuals for the relevant frequencies using scattering theory, for example, in accordance with the Born approximation (e.g. Yoshizawa, K.; Kennett, B. L. N. (2005), Sensitivity kernels for finite-frequency surface waves, Geophysical Journal International, Volume 162, Issue 3, pp. 910-926).

This may be performed in a step 6b as shown FIG. 1 and the kernels may then be used in an iterative tomography.

FIG. 1 illustrates a further step 6c in which three-dimensional sensitivity kernels are calculated connecting variations of the seismic parameters in a three-dimensional model to the resulting phase residuals for different frequencies. This includes the step 7 of FIG. 1, which need not be performed if only the step 6c, and not the steps 6a and 6b, is performed. Thus, a three-dimensional model of seismic parameters is provided directly by the step 6c as shown at 8 in FIG. 1.

If the step 6a and/or the step 6b is performed, the results are maps of phase-velocity and/or group-velocity residuals for each frequency. Together with the reference group and phase dispersions from the step 4, these maps define a dispersion curve for every location in the region being investigated. Each of these dispersion curves may be inverted to provide a one-dimensional model of seismic parameters by applying an appropriate forward modelling algorithm to determine synthetic group-dispersion and phase-dispersion for the one-dimensional models. The gather of the resulting models defines a three-dimensional model of seismic parameters. The dispersion curves of Love and Rayleigh waves may be inverted together.

FIG. 4a illustrates a plurality of stations providing synchronised or simultaneous ambient noise records with each station being illustrated by an inverted triangle. The pairs of records which are processed together are provided by pairs of stations interconnected by a single straight line. The results of the tomography performed in the steps 6a to 7 are illustrated by the Rayleigh velocity maps for each frequency as shown in FIG. 4b. The inversion shown at 15 results in the three-dimensional model of seismic parameters as shown in FIG. 4c and, for example, providing a model of surface wave velocities in the subsurface region being investigated.

The frequency of interest is dependent on the depth of the region of interest as schematically illustrated in FIG. 5. In the upper part of FIG. 5, fundamental-Rayleigh-mode dispersion is shown connecting the excited frequencies with the slowness of propagation. In the lower part of FIG. 5, the amplitude with depth of this Rayleigh wave for three example frequencies is shown. It is an important property of surface waves that the lower the frequency is, the deeper is the penetration depth. In the example of FIG. 5, the low frequency f1 samples the region of interest while the other, higher frequencies sample shallower parts of the subsurface. Therefore, the frequency f1 is the frequency of interest for this example region of interest. The wavelength of interest can be calculated as shown in the equation at the right hand side of FIG. 5. To achieve an optimal lateral resolution for the depth of interest, the inter-station distances for the tomography are distributed between ¼ wavelength of interest and 2 times the wavelength of interest. It is desirable also to measure frequencies higher than the frequency of interest because of the fact that the Rayleigh wave at low frequencies (f1 in FIG. 5) integrates the subsurface properties over a large depth region. If in the last step of the inversion to a subsurface model a conversion from frequency to depth is performed, it is very desirable to have this higher frequency information. The data for this can be recorded with the geometry for the frequency of interest even though the inter-station distance is bigger than the wavelength because, in this depth region, it is not necessary to have the optimal lateral resolution.

It is thus possible to provide a technique which may be applied to the near field, with inter-station distances being smaller than or in the range of a wavelength. This provides greatly improved lateral resolution in the processed data, for example, as compared with the previously described known techniques, which operate in the far field and give insufficient resolution for detecting or monitoring hydrocarbon reservoir-sized structures or features. A systematic approach is provided for first extracting group and/or phase dispersion of Love and/or Rayleigh wave from ambient noise records and then inverting this information together to provide a subsurface model. By providing a reference model of dispersions and calculating residual dispersions, this technique overcomes problems with 2π-jumps in the extracted phases and makes damping during tomographic inversions appropriate.

1.-22. (canceled)

23. A method of detecting or monitoring a subsurface hydrocarbon reservoir by ambient noise tomography, comprising the steps of:
obtaining ambient noise interface wave data at a plurality of pairs of locations in a frequency range greater than or substantially equal to 0.01 Hz and less than or substantially equal to 2 Hz, where the interface wave data at the locations of each pair are obtained simultaneously and the distance between the locations of each of at least some of the pairs is less than or substantially equal to a wavelength of a frequency of interest in the frequency range;
processing the interface wave data at the pairs of locations by tomography to obtain group-velocity and/or phase-velocity tomograms; and
inverting the tomograms to obtain seismic parameter values.

24. A method as claimed in claim 23, comprising the further step of forming a geological model from the seismic parameter values.

25. A method as claimed in claim 23, in which the seismic parameter values are seismic velocity values.

26. A method as claimed in claim 23, in which the interface wave data comprise Rayleigh and/or Love and/or Scholte wave data.

27. A method as claimed in claim 23, in which the interface wave data at the locations of each pair are obtained simultaneously for a time interval of less than ten days.

28. A method as claimed in claim 27, in which the time interval is greater than or substantially equal to 30 minutes.

29. A method as claimed in claim 23, in which the distance between the locations of each of the at least some pairs is less than or substantially equal to the wavelengths of all frequencies of interest.

30. A method as claimed in claim 23, in which the interface wave data are amplitude-normalised.

31. A method as claimed in claim 23, in which the processing step comprises cross-correlating the interface wave data for each pair of locations.

32. A method as claimed in claim 31, in which the processing step comprises extracting Green's functions from the cross-correlations.

33. A method as claimed in claim 23, in which the processing step comprises converting the interface wave data from the distance-time domain to the slowness-frequency or velocity-frequency or wave-number-frequency domain.

34. A method as claimed in claim 23, in which the processing step comprises forming a mean of the group and/or phase dispersion of the interface wave data, determining residual group and/or phase dispersion with respect to the mean, and performing tomography on the residual group and/or phase dispersion.

35. A method as claimed in claim 34, in which the processing step comprises providing sensitivity kernels connecting the residual group and/or phase dispersion to the seismic parameter values at a plurality of different frequencies.

36. A method as claimed in claim 23, in which at least some of the locations are disposed around and above the position of a salt diapir.

37. A method as claimed in claim 23, in which at least some of the locations are disposed around a well at different times for monitoring reservoir property variations during production.

38. A method as claimed in claim 23, comprising selecting the frequency of interest so as to provide the seismic parameters at a depth of interest.

39. A method as claimed in claim 23, comprising performing the processing and inversion steps for a plurality of frequencies of interest to provide the seismic parameters at a plurality of depths of interest so as to provide three dimensional seismic information.

40. A subsurface hydrocarbon survey method, comprising recording ambient noise interface wave data at a plurality of pairs of recording stations in a frequency range greater than or substantially equal to 0.01 Hz and less than or substantially equal to 2 Hz, where the interface wave data at the stations of each pair are recorded simultaneously and the distance between the stations of each of at least some of the pairs is less than or substantially equal to a wavelength of a frequency of interest in the frequency range.

41. A method as claimed in claim 40, in which the interface wave data comprise Rayleigh and/or Love and/or Scholte wave data.

42. A method as claimed in claim 40, in which the interface wave data at the stations of each pair are recorded simultaneously for a time interval of less than ten days.

43. A method as claimed in claim 42, in which the time interval is greater than or substantially equal to 30 minutes.

44. A method as claimed in claim 40, in which the distance between the stations of each of the at least some pairs is less than or substantially equal to the wavelengths of all frequencies of interest.

45. A method as claimed in claim 40, in which the interface wave data are amplitude-normalised.

46. A method as claimed in claim 40, in which at least some of the stations are disposed around and above the position of a salt diapir.

47. A method as claimed in claim 40, in which at least some of the stations are disposed around a well at different times for monitoring reservoir property variations during production.

48. A program for programming a computer to perform a method as claimed in claim 23.

49. A computer-readable medium containing a program as claimed in claim 48.

50. A computer programmed by a program as claimed in claim 48.

51. An apparatus arranged to perform a method as claimed in claim 23.

52. An apparatus arranged to perform a method as claimed in claim 40.
